(19) United States
(12) Patent Application Publication
(10) Pub. No.: US 2022/0158679 A1
(43) Pub. Date: May 19, 2022

(54) EMF and Microbe Resistant Cell Phone Cover

(71) Applicants: Patrick Owen FITZGERALD, Boise, ID (US); Nancy Jean JOHNSON, Mead, WA (US); Dennis Terenzio, Boise, ID (US)

(72) Inventors: Patrick Owen FITZGERALD, Boise, ID (US); Nancy Jean JOHNSON, Mead, WA (US); Dennis Terenzio, Boise, ID (US)

(21) Appl. No.: 17/531,690

(22) Filed: Nov. 19, 2021

Related U.S. Application Data
(60) Provisional application No. 63/116,118, filed on Nov. 19, 2020.

(51) Int. Cl. H04B 1/3888; H04B 1/3827

(52) U.S. Cl. CPC H04B 1/3888; H04B 1/3838

(57) ABSTRACT

A protective cover for a cell phone is formed as a trough having a generally rectangular rimmed base configured to embrace a rear surface and four sides of the cell phone. The cover has an EMF shield rotatable among closed, intermediate, and open positions. The EMF shield in the closed position lies parallel to and screens a display surface opposite the rear surface of the cell phone. The EMF shield in the intermediate position provides a stand configured to support the display surface at a landscape orientation angled with respect to horizontal. The EMF shield in the closed position lies parallel to and screens the rear surface. Rotation of the EMF shield may be effected by a double living hinge strengthened by a metal mesh that forms a Faraday cage for shielding a user from EMF generated by the cell phone.

### RELATED APPLICATIONS

This application claims priority to U.S. Provisional Application 63/116,118 that was filed on Nov. 19, 2020 and which is fully incorporated herein by reference.

### BACKGROUND OF THE INVENTION

### Field of the Invention

The present invention relates generally to protective covers for mobile phones, and more specifically to cell phone covers that act as display stands, and to cell phone covers that protect users from exposure to microbes and to electric and magnetic fields (EMF).

### Description of Related Art

Mobile phones are in ubiquitous usage today. Given the high frequency of usage and handling, mobile phones can expose users to potential dangers such as EMF and bacterial and viral infections. Because potentially harmful EMF are generated by the phone itself, an EMF-resistant protective device that attaches to the phone may not able to adequately shield a user who is in very close proximity to the phone. What is needed is an advancement in the design of protective cell phone covers that provides both anti-microbial and EMF protection, and that doesn't rely solely on an EMF shield attached to the phone to protect users from EMF that are generated by the phone itself.

### SUMMARY OF THE INVENTION

The present invention provides an engineered design for a protective cell phone cover that shields users from EMF by using a combination of features. These features include a specialized EMF shield that acts as a Faraday cage, a system of magnetic locks for positioning the EMF shield, and a mechanical stand that maintains a phone at a portrait or angled landscape orientation to allow a user to interact with the phone at a safe distance. The protective cell phone cover may also provide anti-microbial protection to prevent or inhibit growth or accumulation of certain bacteria, fungi, and viruses.

In one embodiment, a protective cell phone cover according to the invention includes a trough having a generally rectangular rimmed base configured to embrace a rear surface and four sides of the cell phone, and an EMF shield rotatable among closed, intermediate, and open positions. The EMF shield in the closed position lies parallel to and screens a display surface opposite the rear surface of the cell phone, the EMF shield in the intermediate position provides a stand configured to support the display surface at a landscape orientation angled with respect to horizontal, and the EMF shield in the closed position lies parallel to and screens the rear surface.

In other embodiments, the protective cover for the cell phone may further include a magnetic attachment means for latching the EMF shield to the closed position, a magnetic attachment means for latching the EMF shield to the open position, or a mechanical means for latching the EMF shield to the intermediate position. In another embodiment, the aforedescribed protective cover for the cell phone may include an EMF shield having one or more permanent magnets, wherein the trough comprises one or more permanent magnets, and wherein at least one of the permanent magnets of the EMF shield latches to at least one of the permanent magnets of the trough when the EMF shield is in the open position and when the EMF shield is in the closed position.

In more elaborate embodiments, a cell phone cover according to the present invention may provide an EMF shield that includes a Faraday cage, either on a surface of the EMF shield, or coated with an injection-molded synthetic rubber or plastic. The Faraday cage may be a metal plate, or mesh, or perforated sheet. The EMF shield may incorporate or be covered with an antimicrobial material, such as a superhydrophobic material consisting of polyurethane faux leather or a metal-infused fabric.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is a frontal perspective view of one embodiment according to the invention of an EMF and microbe resistant cell phone cover, as installed on a cell phone.

FIG. 2 is another frontal perspective view of the same cell phone and cover, rotated a few degrees counterclockwise.

FIG. 3 is a left side view of the same cell phone and cover.

FIG. 4 is a rear perspective view of the same cell phone and cover, rotated another 45 degrees counterclockwise.

FIG. 5 is a rear view of the same cell phone and cover.

FIG. 6 is another rear perspective view of the same cell phone and cover, rotated 90 degrees counterclockwise with respect to the view of FIG. 4.

FIG. 7 is a right side view of the same cell phone and cover.

FIG. 8 is another frontal perspective view of the same cell phone and cover, rotated 90 degrees counterclockwise with respect to the view of FIG. 6.

FIG. 9 is a front view of the same cell phone and cover.

FIG. 10 is a right frontal perspective view of the same cell phone cover, showing a protective shield rotated to an intermediate position that provides a desktop stand for the phone in portrait orientation.

FIG. 11 is a left frontal perspective view of the same cell phone and cover in the same configuration as in FIG. 10.

FIG. 12 is a frontal perspective view of the same cell phone and cover as shown in FIG. 10, positioned in landscape orientation.

### DETAILED DESCRIPTION OF THE INVENTION

The following disclosure presents exemplary embodiments for a protective cell phone cover that shields users from EMF by using a combination of features. These features include a specialized EMF shield that acts as a Faraday cage, a system of magnetic locks for positioning the EMF shield, and a mechanical stand that maintains a phone at a portrait or angled landscape orientation to allow a user to interact with the phone at a safe distance. The protective cell phone cover may also provide anti-microbial protection to prevent or inhibit growth or accumulation of certain bacteria, fungi, and viruses.

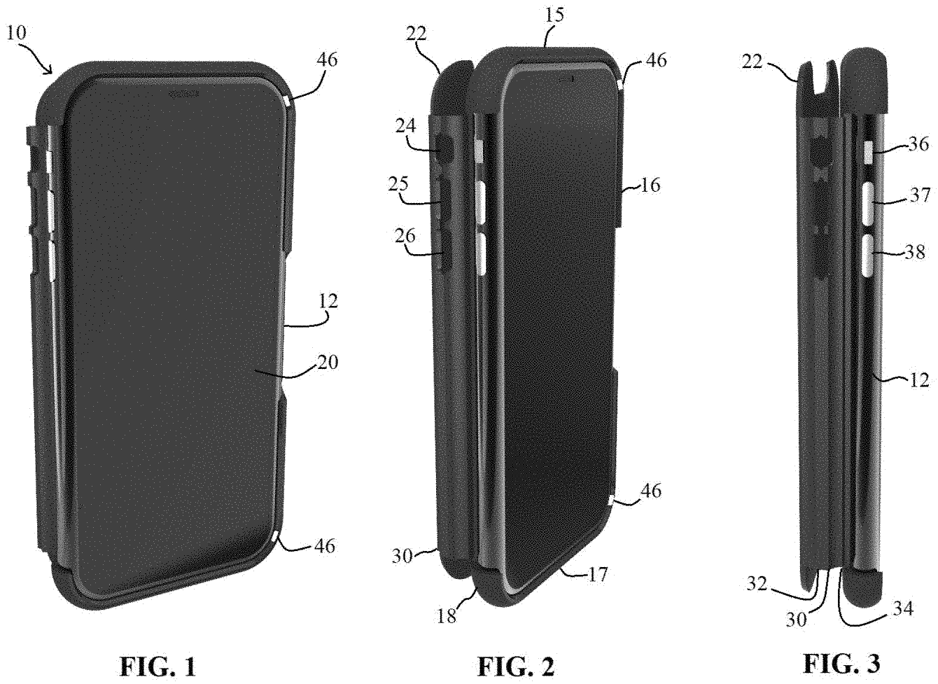

FIG. 1 shows a frontal perspective view of one embodiment according to the invention of an EMF and microbe resistant cell phone cover 10, as installed on a cell phone 12. Generally, phone cover 10 is constructed as a trough having a generally rectangular, rimmed base 14. Rimmed portions 15, 16, 17 and 18 of the base 14 each cover a top, right, bottom, or left side, respectively, of the cell phone 12, as shown. The phone cover 10 is thus configured to embrace a rear surface and each of four sides of the cell phone 12. Opposite the rear surface of the cell phone 12 is the display surface 20.

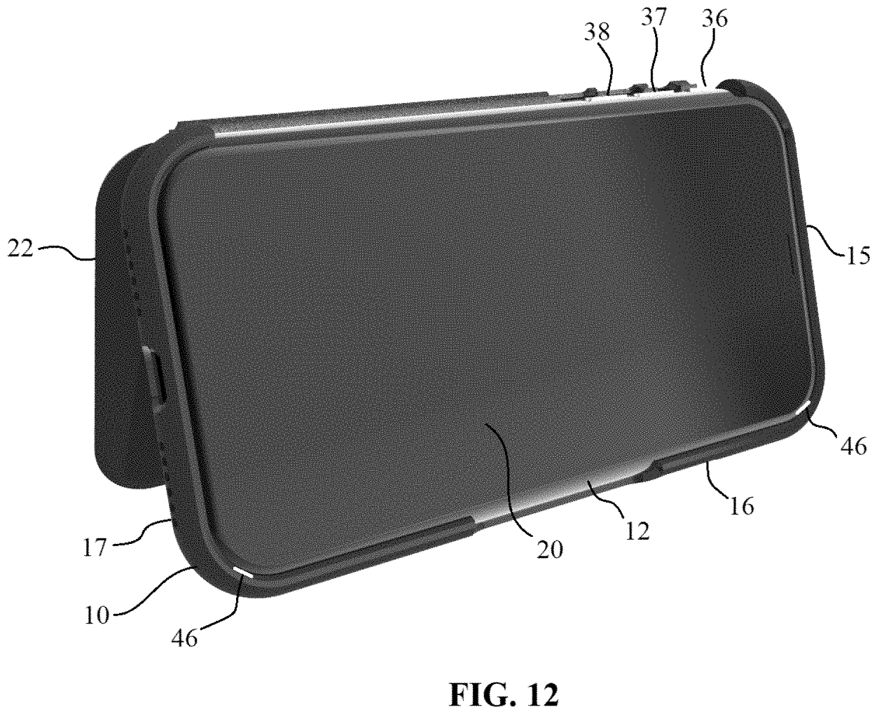

An EMF shield 22 is rotatably connected to the base 14 of the trough. The EMF shield 22 can be rotated with respect to the base 14 to the closed position, to the open position, or to an intermediate position. In the closed position, the EMF shield 22 substantially covers the display surface 20 of the cell phone 12. That is, in the closed position, EMF shield 22 lies substantially parallel to display surface 20, and substantially screens the display surface 20 from the view of a user. Thus, when EMF shield 22 is in the closed position, no part of the display surface 20 is exposed. In the open position, the EMF shield 22 lies substantially parallel to the rear surface of the base 14. Thus, when the EMF shield is in the open position as shown in FIG. 1, the display surface 20 is exposed and viewable, and the rear surface of the base 14 is substantially covered or screened by the EMF shield 22. Any rotational or angular position of the EMF shield 22 between the closed position and the open position is an intermediate position. Among the intermediate positions, the EMF stand may be locked or removably latched into a particular intermediate position to provide a stand configured to support the display surface 20 at a landscape configuration angled with respect to the horizontal. See, e.g., FIG. 12.

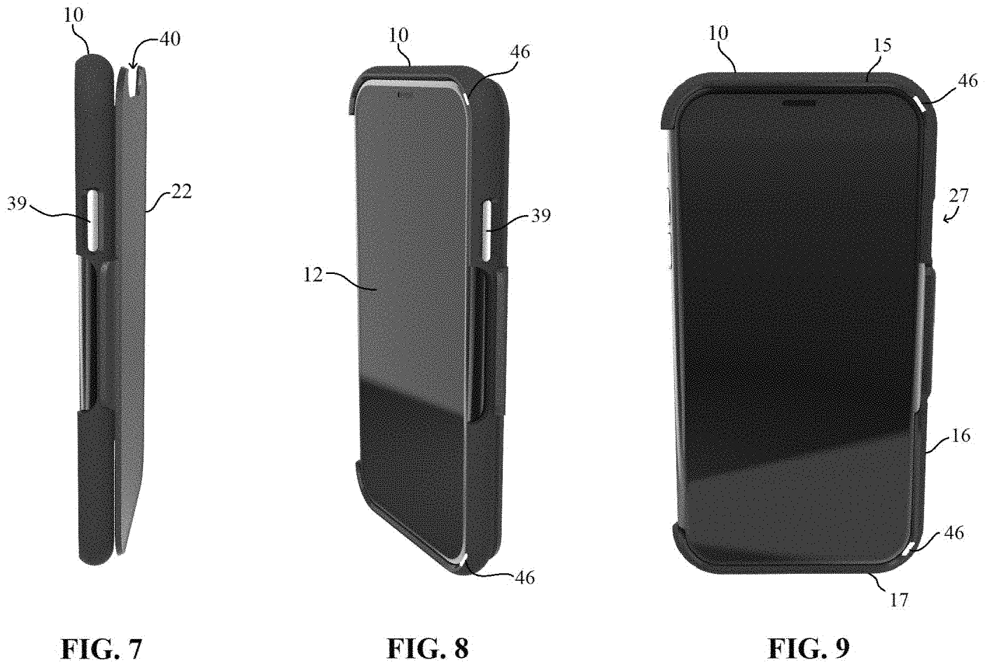

FIGS. 2 through 9 show various different perspective, side, or front views of the cell phone 12 embraced within the protective cell phone cover 10, with the EMF shield in the open position. Each figure in succession shows the same cell phone 12 and cover 10 image rotated about 30 to 45 degrees counterclockwise with respect to image shown in the prior figure. FIG. 2 in particular shows a hinge plate 30 that is designed to cover one side of the cell phone 12—in this case, the left side. In one embodiment, hinge plate 30 provides a double hinge. For example, the hinge plate 30 may be rotatably connected along its forward edge to the EMF shield 22 by a hinge 32. And in addition, the hinge plate 30 may be rotatably connected along its rearward edge to the base 14 by a hinge 34. One or both of hinges 32 and 34 may be a living hinge, or the hinges 32 and 34 may form a double living hinge. In other embodiments, one or both of hinges 32 and 34 may be a plano style hinge, or may have the form of any other conventional hinge. Note that in FIGS. 1 to 9, with the EMF shield 22 rotated to the open position, hinge 32 at the forward edge of hinge plate 30 has been rotated to a position behind the rearward edge of hinge plate 30 and hinge 34.

Hinge plate 30 may also be formed with one or more apertures 24, 25, 26 which are sized and located to allow access to pushbuttons 36, 37, 38 that are mounted on a side of the cell phone 12. Various embodiments according to the invention may have different numbers and locations of such apertures, defined through the hinge plate 30, and customized for compatibility with different phone configurations. Similarly, on a side of the phone cover 10 opposite that of the hinge plate 30, one or more apertures 27 may be sized and located to allow access to one or more pushbuttons 39. For example, certain configurations of an iPhone® or Android® phone may provide pushbuttons located on a side of the phone to switch volume on or to mute, to adjust volume up or down, or to power the phone on or off. The apertures 24, 25, 26, 27 are provided to allow a user unhindered access to such pushbuttons, whether located on a right, left, top, bottom, front, or rear side of the cell phone 12.

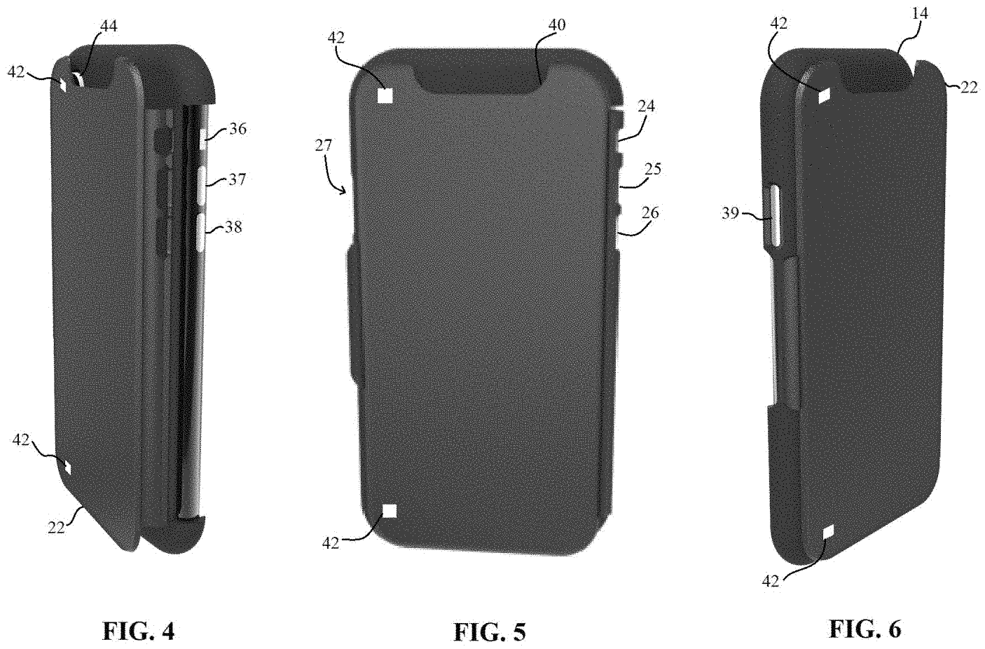

The phone cover 10 may also be configured to latch the EMF shield 22 to the open position or to the closed position. In one embodiment, the phone cover 10 effects this latch by means of magnetic materials cooperatively connected to two or more locations on the EMF shield 22, on the base 14, or on a rimmed portion 15, 16, 17 and 18 of the base 14. For example, a magnetic material 42 may be attached to a fixed location on the EMF shield 22. In one example, as depicted in each of FIGS. 4-6, a magnetic material 42 may be attached to a first location on the EMF shield 22 near the outer edge of the EMF shield, that is, near the edge that is opposite hinge 32. A second and cooperative magnetic material 44 or 46 may be attached to the trough at a location adjacent to magnetic material 42 when the EMF shield 22 is in either the open position or the closed position. Adjacent placement of two magnetic materials means a proximity between the two materials whereby their cooperative magnetic forces will cause the two materials to latch together when the angular position of the EMF shield 22 approaches either the open or the closed position, and thereby maintain the cell phone cover 10 latched open or closed under the force of magnetic attraction. The force of the magnetic latch is such that it will retain the latch under counter force of gravity, but can be easily unlatched by manual force.

At least one of the magnetic materials 42, 44, 46 comprises a permanent magnet, made from a metal such as iron or nickel. One of the magnetic materials 42, 44, 46 may be a ferrous material such as steel that is susceptible to magnetic attraction. In one embodiment, a magnetic material 42, 44, 46 may be an assembly formed as a block or fragment of a permanent magnet that is attached to a metal plate or enclosed within a metal case. In another embodiment, the metal plate or case may be connected, e.g., by friction-fit, welding, or adhesive, to the EMF shield 22. In another embodiment, where the EMF shield 22 comprises a metal mesh inlay within an injection-molded dielectric, the magnetic material 42, 44, 46 may be welded to the metal mesh prior to performing a mold injection process. In another embodiment, where the EMF shield 22 comprises a metal mesh inlay or thin metal plate, and wherein one or both of hinges 32 and 34 form a living hinge, a portion of the metal mesh inlay or thin metal plate may wrap around the seam of one or both of the hinges 32 and 34 to strengthen one or both of the living hinges.

In one embodiment, a cell phone cover 10 includes one or more permanent magnets 42 affixed to the rotatable EMF shield 22. The cell phone 10 further includes a first set of cooperatively located magnetic material 44 on the rear surface of the base 14 as in FIG. 4, and a second set of cooperatively located magnetic material 46 on the front surface of rimmed portions 16 (FIG. 9). Thus, the permanent magnet or magnets 42 will latch to the first set of magnetic material 44 when the EMF shield is rotated to the closed position, or will latch to the second set of magnetic material 46 when the EMF shield is rotated to the open position. Skilled artisans will appreciate that the second set of cooperatively located magnetic materials 44 may alternatively be placed on the front surface of rimmed portion 15 or 17 and achieve similar functionality.

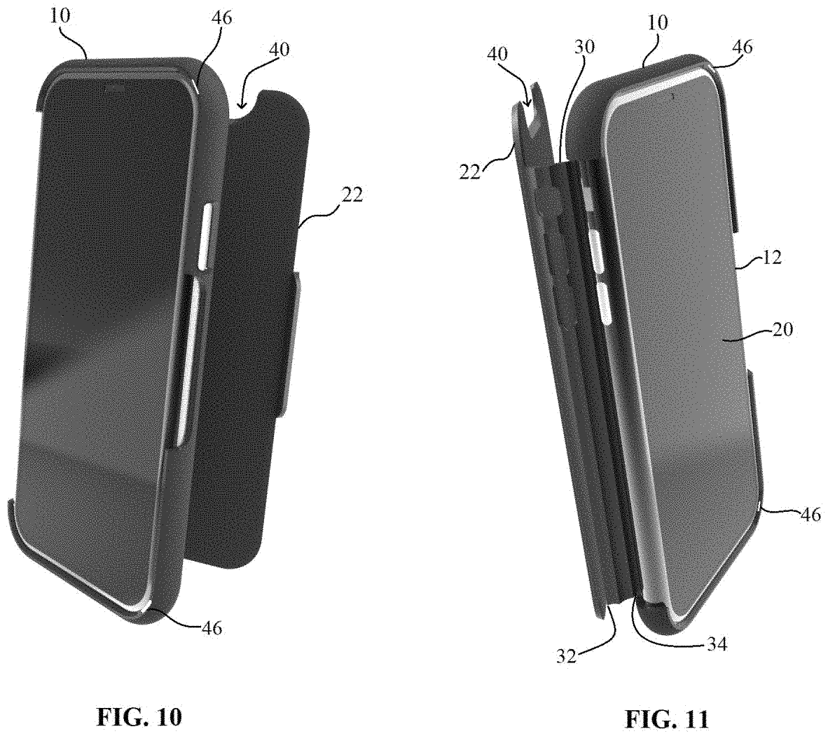

FIG. 10 shows a right frontal perspective view of a cell phone 12 embraced by the cell phone cover 10. In this view, the protective EMF shield 22 is rotated about 45 degrees off of the open position to an intermediate position that provides a desktop stand for the phone in portrait orientation, as shown. Other intermediate positions can be achieved, by rotating the EMF shield 22 to an angle greater or less than 45 degrees, that suitably configure the cell phone cover 10 to function as a desktop stand. FIG. 11 shows a left frontal perspective view of the cell phone 12 embraced by the cell phone cover 10, arranged in the same configuration as in FIG. 10. In one embodiment, as best shown in FIGS. 10 and 11, the EMF shield 22 may include a void 40 formed along a top edge of the EMF shield. The purpose of the void 40 is to provide an open area to permit light to pass through the EMF shield, when the EMF shield is in the closed position, to allow unobstructed operation of a camera lens, LED, or other light sensing or light generating component of cell phone 12.

FIG. 12 shows a frontal perspective view of cell phone 10 embraced by the cell phone cover 12 and arranged as in FIG. 10, except that the assembly has been rotated 90 degrees to a landscape orientation. Thus, the EMF shield 22 when rotated to an intermediate position can also function as a stand to support the cell phone 12 on a desktop in landscape orientation. Whether supporting the cell phone 12 in a landscape or portrait orientation, the EMF shield 22 may be releasably mechanically latched into a fixed angle in an intermediate position. Examples of mechanical means for enabling such releasable latch include a cooperating gear and locking pawl, a high-friction bearing, and a hinge pin that engages a spring-loaded lock. By configuring the cell phone cover 10 with the rotatable EMF shield 22 so that is can function as a desktop stand, the invention advantageously allows a user to interact with the phone at a distance to reduce the intensity of the user's exposure to EMF generated by the cell phone 12 itself.

The material make-up of the EMF shield 22 also protects a user from exposure to EMF. According to the invention, the EMF shield 22 is formed from, or may include, one or more metals formed as a Faraday cage to protect a user from EMF generated by the cell phone 10. Metal such as copper, aluminum, or steel (e.g. carbon steel, or 304 or 312 medical grade stainless) formed as a plate, or as a mesh, or a combination of plate portions and mesh portions, made from one or more than one such metal, may entirely, substantially, or partially comprise the EMF shield 22. In one embodiment, the EMF shield is formed by a injection molding a dielectric material such as plastic or synthetic rubber around an inlay made from the metal plate or metal mesh or from a perforated metal sheet. The EMF shield formed in this manner may thus consist of multiple layers of dielectric and metal materials. In one embodiment, the metal portion of the EMF shield 22 is forms a surface on the shield. In another embodiment, the metal portion of the EMF shield is at least partially embedded within the dielectric.

The protective cell phone cover 10 may also provide anti-microbial protection to prevent or inhibit growth or accumulation of certain bacteria, fungi, and viruses. In one embodiment, the anti-microbial protection is provided by an EMF shield having a surface that is superhydrophobic. In another embodiment, antimicrobial protection is provided by an antimicrobial additive used in the injection-mold process. For example, powders or liquids or polymer pellets (e.g. thermoplastic polyurethane pellets) used in the injection molding process may be infused with an active ingredient inimical to microbial growth prior to injecting liquefied plastic into the mold. In another embodiment, an outer layer of superhydrophobic or otherwise anti-microbial fabric may be attached to the metal or injection-molded EMF shield. The superhydrophobic fabric may enclose the metal component of the EMF shield 22 and also any of the permanent magnets 42 44, 46. The superhydrophobic fabric may also enclose the outer surfaces of the trough of the cell phone cover 10. A polyurethane fabric or other faux leather fabric may be used as the superhydrophobic fabric in any of the embodiments herein. In one implementation, such a fabric may be infused with zinc and/or copper oxides and/or silver ions, all of which have been proven effective in destroying viruses, particularly lipid-enveloped viruses like coronavirus. Other antimicrobial metals that may be combined with the dielectric or fabric components that make up the EMF shield include any of the transition metals of the d-block (V, Ti, Cr, Co, Ni, Cu, Zn, Tb, W, Ag, Cd, Au, Hg), as well as metals and metalloids from groups 13-16 of the periodic table such as Al, Ga, Ge, As, Se, Sn, Sb, Te, Pb and Bi. In one embodiment, the EMF shield 22 comprises a metal enriched thermoplastic or synthetic elastomer that includes at least one of the aforesaid d-block or group 13-16 metals as a constituent.

Other more elaborate embodiments of the invention include those in which the EMF shield 22 is further configured with alternative or additional attachment means to allow the cell phone 10 to be mounted to structures that will allow a user to use the phone while maintaining a safe distance that minimizes exposure to EMF. Attachment means such as suction cups, clips, clothing pins, and automobile dashboard fasteners are contemplated within the scope of the invention.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A protective cover for a cell phone, comprising:
a trough having a generally rectangular rimmed base configured to embrace a rear surface and four sides of the cell phone; and
an EMF shield rotatable among closed, intermediate, and open positions;
wherein the EMF shield in the closed position lies parallel to and screens a display surface opposite the rear surface of the cell phone;
wherein the EMF shield in the intermediate position provides a stand configured to support the display surface at a landscape orientation angled with respect to horizontal; and
wherein the EMF shield in the closed position lies parallel to and screens the rear surface.

2. The protective cover of claim 1 configured to fully enclose the cell phone when the EMF shield is in the closed position.

3. The protective cover of claim 1 further comprising magnetic attachment means for latching the EMF shield to the closed position.

4. The protective cover of claim 1 further comprising magnetic attachment means for latching the EMF shield to the open position.

5. The protective cover of claim 1 further comprising mechanical means for latching the EMF shield to the intermediate position.

6. The protective cover of claim 5 wherein the mechanical latching means comprises a locking pawl.

7. The protective cover of claim 1 wherein the EMF shield further comprises one or more permanent magnets, wherein the trough comprises one or more permanent magnets, and wherein at least one of the permanent magnets of the EMF shield latches to at least one of the permanent magnets of the trough when the EMF shield is in the open position and when the EMF shield is in the closed position.

8. The protective cover of claim 7 wherein at least one of the permanent magnets of the EMF shield is at least partially enclosed in a metal case and wherein the metal case is electrically coupled to the EMF shield.

9. The protective cover of claim 8 wherein the EMF shield comprises a metal mesh and wherein the metal case is welded to the metal mesh.

10. The protective cover of claim 9 wherein the EMF shield and the permanent magnets of the EMF shield are enclosed within a superhydrophobic material.

11. The protective cover of claim 1 wherein outer surfaces of the trough and the EMF shield comprise superhydrophobic material.

12. The protective cover of claim 11 wherein the superhydrophobic material comprises a metal enriched thermoplastic.

13. The protective cover of claim 11 wherein the superhydrophobic material comprises a metal enriched synthetic elastomer.

14. The protective cover of claim 1 wherein outer surfaces of the EMF shield comprise superhydrophobic material.

15. The protective cover of claim 14 wherein the superhydrophobic material comprises a metal enriched synthetic elastomer.

16. The protective cover of claim 14 wherein outer surfaces of the EMF shield comprise superhydrophobic material.

17. The protective cover of claim 1 wherein the EMF shield comprises a metal mesh.

18. The protective shield of claim 17 wherein the EMF shield comprises superhydrophobic material in which the metal mesh is embedded.

19. The protective cover of claim 1 wherein the EMF shield is coupled to the trough by a double living hinge.

20. The protective cover of claim 19 wherein the double living hinge comprises one or more seams, wherein the EMF shield comprises a metal mesh, and wherein a portion of the metal mesh wraps around the one or more seams to strengthen the double living hinge.
